(19) United States
(12) Patent Application Publication
(10) Pub. No.: US 2021/0162474 A1
(43) Pub. Date: Jun. 3, 2021

(54) ORGANIC MATTER PROCESSING APPARATUS

(71) Applicants: Yoshiaki MIYAZATO, Tokyo (JP); THE BIZSER CO., LTD., Tokyo (JP); WINSTAR DEVELOPMENT GROUP, Tokyo (JP)

(72) Inventors: Yoshiaki MIYAZATO, Chuo-ku, Tokyo (JP); Young Kwon KIM, Shinjuku-ku, Tokyo (JP); Dae Ki PARK, Shinjuku-ku, Tokyo (JP)

(73) Assignees: THE BIZSER CO., LTD., Tokyo (JP); WINSTAR DEVELOPMENT GROUP, Tokyo (JP); Yoshiaki MIYAZATO, Tokyo (JP)

(21) Appl. No.: 17/048,013

(22) PCT Filed: Apr. 20, 2018
(86) PCT No.: PCT/JP2018/016353

§ 371 Date: Oct. 15, 2020

(51) Int. Cl. B09B 3/00; B01D 29/66; C02F 1/00; C02F 3/34

(52) U.S. Cl. CPC B09B 3/00; B01D 29/66; C02F 2101/30; C02F 3/34; C02F 2303/16; C02F 1/001

(57) ABSTRACT

Provided is an organic matter processing apparatus, etc. that allows easy maintenance of a filter, and does not require a processing facility for a by-product. An organic matter processing apparatus S includes a processing tank 2 in which decomposition processing of organic matter is performed by a microorganism, a filter unit 20 including a filter 21 for removing solid matter included in a waste fluid generated by the decomposition processing, a reservoir 35 that stores the waste fluid from which the solid matter is removed by the filter unit 20, and a waste fluid circulation unit 40 that returns the waste fluid stored in the reservoir 35 to the processing tank 2.

### TECHNICAL FIELD

The present invention relates to an organic matter processing apparatus that performs decomposition processing of organic matter, such as food waste, by a microorganism.

### BACKGROUND ART

Recently, with growing concern about environmental pollution due to food waste, a variety of food waste processing methods have been studied.

As an example of a food waste processing technique, a food waste processing apparatus is known that accommodates porous base materials, such as sawdust and woodchips, and microorganisms in a processing tank, putting and mixing food waste in the processing tank, and performs decomposition processing on this food waste by the microorganisms (for example, refer to Patent Literature 1).

The food waste processing apparatus shown in Patent Literature 1 generates compost by decomposing and reducing food processing residues.

### CITATION LIST

### Patent Literature

Patent Literature 1: Japanese Patent No. 3001852

### SUMMARY OF INVENTION

### Technical Problem

Incidentally, although this kind of food waste processing apparatus can reduce the volume of food waste, there has been a problem that a by-product discharged from the food waste processing apparatus must be reprocessed.

Additionally, although the processed materials subjected to decomposition processing and discharged by the food waste processing apparatus are generally discharged to a sewer, etc., since solid matters are included in the processed materials, a problem such as clogged pipes may be caused.

Further, when the solid matters included in the processed materials are removed with a filter, the filter is quickly clogged, the replacement frequency of the filter is shortened, and it is difficult to maintain the filter.

Therefore, an object of the present invention is to provide an organic matter processing apparatus, etc. that allows easy maintenance of a filter, and does not require a processing facility for a by-product.

### Solution to Problem

In order to achieve the above-described object, an organic matter processing apparatus according to claim 1 includes a processing tank (2) in which decomposition processing of organic matter is performed by a microorganism, a filter unit (20) including a filter (21) for removing solid matter included in a waste fluid generated by the decomposition processing, a reservoir (35) that stores the waste fluid from which the solid matter is removed by the filter unit, and a waste fluid circulation unit (40) that returns the waste fluid stored in the reservoir to the processing tank.

Additionally, the invention according to claim 2 includes, in the organic matter processing apparatus according to claim 1, a washing unit (50) that removes the solid matter adhered to the filter to wash the filter unit.

Additionally, in the invention according to claim 3, in the organic matter processing apparatus according to claim 2, the washing unit includes a solid matter circulation unit (20, 74) that returns the solid matter removed from the filter to the processing tank.

Additionally, in the invention according to claim 4, in the organic matter processing apparatus according to any one of claims 1 to 3, the solid matter circulation unit sends back the waste fluid discharged from the filter unit to the filter unit.

Additionally, in the invention according to claim 5, the organic matter processing apparatus according to any one of claims 1 to 4 includes a first flow channel (71) that communicates the processing tank with one end side of the filter unit, a second flow channel (72) that communicates the other end side of the filter unit with the reservoir, a third flow channel (73) that communicates the reservoir with the processing tank, a fourth flow channel (74) that communicates the one end side of the filter unit with the processing tank, valves (B1 to B8) that open or close the respective flow channels, and a control unit that controls opening and closing of each of the valves, wherein the control unit opens or closes each of the valves to open or close each of the flow channels.

Additionally, an organic matter processing method according to claim 6 includes a decomposition processing step of performing decomposition processing of organic matter by a microorganism in a processing tank into which the organic matter is put, a solid matter removing step of removing solid matter included in a waste fluid generated by the decomposition processing, and a waste fluid circulating step of returning the waste fluid from which the solid matter is removed to the processing tank.

### Advantageous Effects of Invention

According to the present invention, since the waste fluid on which the decomposition processing has been performed by the microorganism is reused, a by-product is not generated by processing of food waste. Additionally, even in a case where disposal processing is performed on the waste fluid, since the solid matter included in the waste fluid has been removed, even when the waste fluid is discharged to the sewer, etc., pipes will not be clogged and the disposal processing is easy.

Further, since the filter is washed by using the waste fluid, it is possible to extend the service life of the filter, and the maintenance of the filter is easy.

### BRIEF DESCRIPTION OF DRAWINGS

FIG. 1 is a schematic diagram showing the external appearance of a food waste processing apparatus seen from behind.

FIG. 2 is a left side view showing the external appearance of the food waste processing apparatus.

FIG. 3 is a right side view showing the external appearance of the food waste processing apparatus.

FIG. 4 is a schematic diagram for describing the inside of a processing tank of the food waste processing apparatus.

FIG. 5 is a schematic diagram for describing the inside of a body case.

FIG. 6 is a schematic diagram showing a configuration example of an apparatus for stirring food waste.

FIG. 7 is an A-A cross-sectional view of FIG. 6.

FIG. 8 is a schematic diagram for describing the inside of a filter unit.

FIG. 9 is a partial enlarged view for describing the actions of a filter: FIG. 9(a) is a diagram describing a purification function of a waste fluid; and

FIG. 9(b) is a diagram describing a removing function of solid matters adhered to the filter.

FIG. 10 is a schematic diagram for describing an exemplary processing operation of the waste fluid in the food waste processing apparatus.

FIG. 11 is a schematic diagram for describing an exemplary operation of reusing processing of the waste fluid in the food waste processing apparatus.

FIG. 12 is a schematic diagram for describing an exemplary operation of washing processing of the filter in the food waste processing apparatus.

### DESCRIPTION OF EMBODIMENT

Hereinafter, examples of a fixing apparatus according to the present invention will be described with reference to the drawings. Note that the following examples do not limit the invention according to each of the claims, and not all the combinations of features described in the examples are essential to the solution of the invention.

### (Outline of Food Waste Processing Apparatus)

A food waste processing apparatus S in the present embodiment is based on a microorganism decomposition processing system, includes a processing tank 2 having a predetermined space, accommodates a carrier for a microorganism (pieces of wood carrying a microorganism, etc.), not shown, and food waste in this processing tank 2, and performs decomposition processing of this food waste by the microorganism. Additionally, the food waste processing apparatus S circulates a waste fluid generated by the decomposition processing by the microorganism, without performing disposal processing, and after removing solid matters included in the waste fluid and purifying the waste fluid, the food waste processing apparatus S returns the waste fluid to the processing tank 2. Further, the solid matters removed from the waste fluid are also returned to the processing tank 2, and the decomposition processing is performed on the solid matters again by the microorganism.

Accordingly, since the food waste processing apparatus S of the present embodiment purifies the waste fluid on which the decomposition processing has been performed by the microorganism, thereafter returns the waste fluid to the processing tank 2, and reuses the waste fluid to perform decomposition processing of food waste, it is unnecessary to perform the disposal processing. Additionally, even if the disposal processing of the waste fluid is performed, since solid matters included in the waste fluid have been removed, it is possible to prevent pipes of the sewer, etc. from being clogged.

### (Configuration of Food Waste Processing Apparatus)

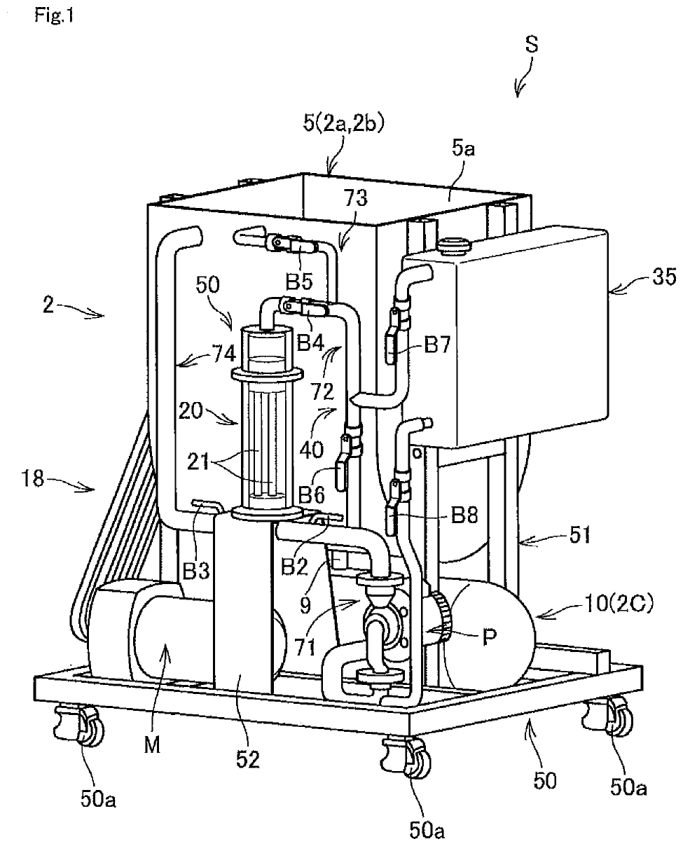

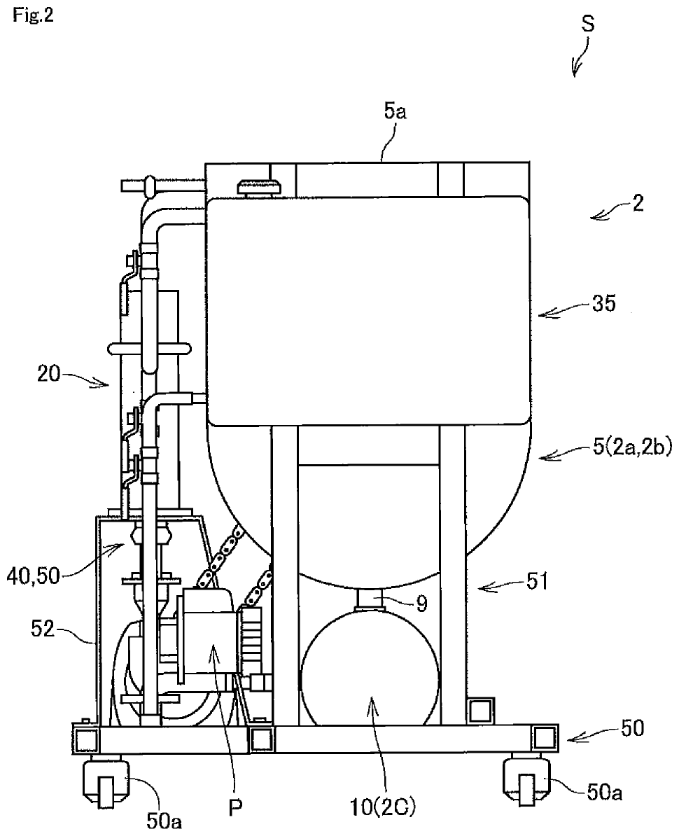

As shown in FIG. 1 to FIG. 3, the food waste processing apparatus S includes a processing tank 2 that performs decomposition processing of organic matter, such as food waste, by a microorganism, a filter unit 20 including a filter 21 that removes and purifies the solid matters included in the waste fluid by filtering the waste fluid that has been processed in the processing tank 2, a storage tank 35 (a reservoir of the present application) that stores the purified waste fluid, a waste fluid circulation unit 40 that returns the waste fluid in the storage tank 35 to the processing tank 2, and a washing unit 50 that removes the solid matters adhered to the filter 21 of the filter unit 20 to wash the filter 21.

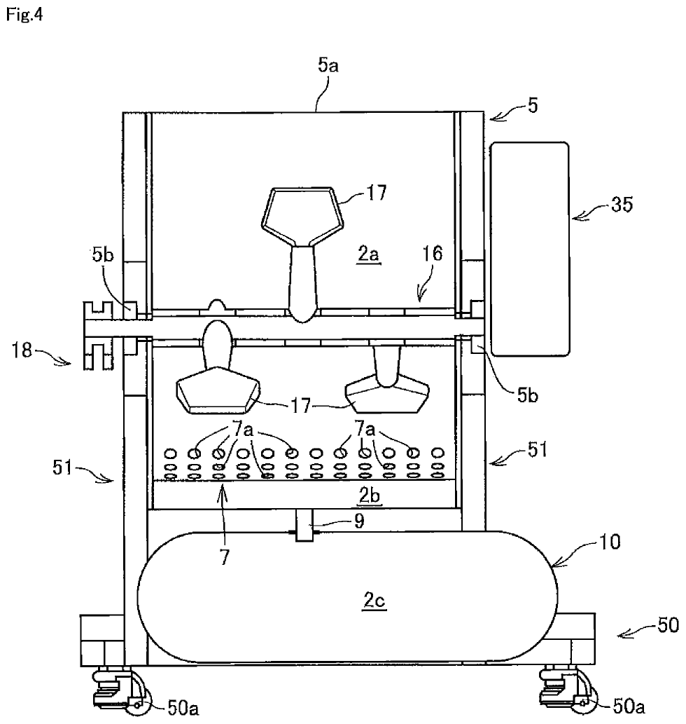

As shown in FIG. 1 and FIG. 4, the processing tank 2 includes a body case 5 that functions as a first processing tank 2a and a second processing tank 2b, and a subcase 10 that functions as a third processing tank 2c provided as a separate body from this body case 5 via a communication passage 9.

As shown in FIG. 1, the body case 5 and the subcase 10 are placed on base 50 constituted by a plurality of square pipes, and the body case 5 is supported by a pair of left and right support bodies 51 constituted by a plurality of square pipes rising from the base 50. Additionally, the filter unit 20 is placed on a stand 52 that is behind the body case 5 and placed on the base 50, and the storage tank 35 is supported by the support bodies 51 on the right-hand side of the body case 5.

Additionally, casters 50a are attached under the base 50, and the food waste processing apparatus S can be freely moved on a floor with these casters 50a. Note that these casters 50a are not essential components, and are provided when necessary.

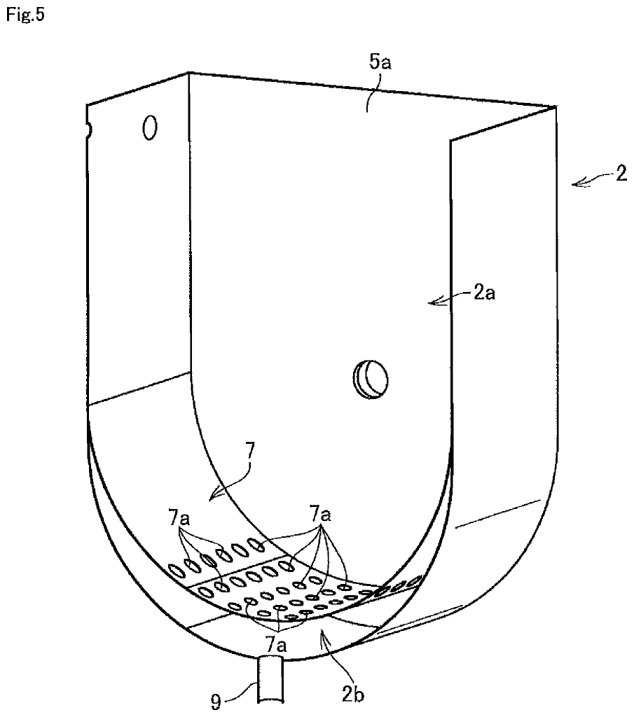

As shown in FIG. 1 and FIG. 5, the body case 5 is formed by metal panels, etc. into a bottomed square cylinder shape including the lower end formed into a substantially U-shape having an arc-shape in cross section so that processed matters gather in a center portion, and includes, at the upper end, an opening 5a that functions as an input port through which a microorganism carrier and food waste are input.

On the other hand, the subcase 10 functions as the third processing tank 2c, and includes a housing having a cylindrical space that can accommodate the food waste processed in the body case 5. This subcase 10 communicates with the body case 5 via the communication passage 9, and is arranged under the body case 5.

Additionally, as shown in FIG. 4 and FIG. 5, the inside of the body case 5 is divided into the first processing tank 2a and the second processing tank 2b via a partition body 7 that partitions the inside into the top and bottom. This partition body 7 is formed by curving, for example, a metal thin plate into a shape similar to the lower end of the body case 5, and is attached to the inside of the body case 5.

Additionally, a plurality of through-holes 7a, 7a penetrating in the vertical direction are formed substantially in the vicinity of the center portion of this partition body 7. The opening diameter of the through-hole 7a formed in this partition body 7 is formed to be larger than the opening diameter of the communication passage 9, and it is preferable that food waste on which the decomposition processing has been performed by each of the processing tanks 2a to 2c is gradually subdivided.

Additionally, as shown in FIG. 4, a stirring shaft 16 is rotatably provided in the horizontal direction between the left and right side walls inside the body case 5, and a plurality of stirring wings 17 extending in the direction perpendicular to the axial direction are provided on this stirring shaft 16 at a predetermined interval.

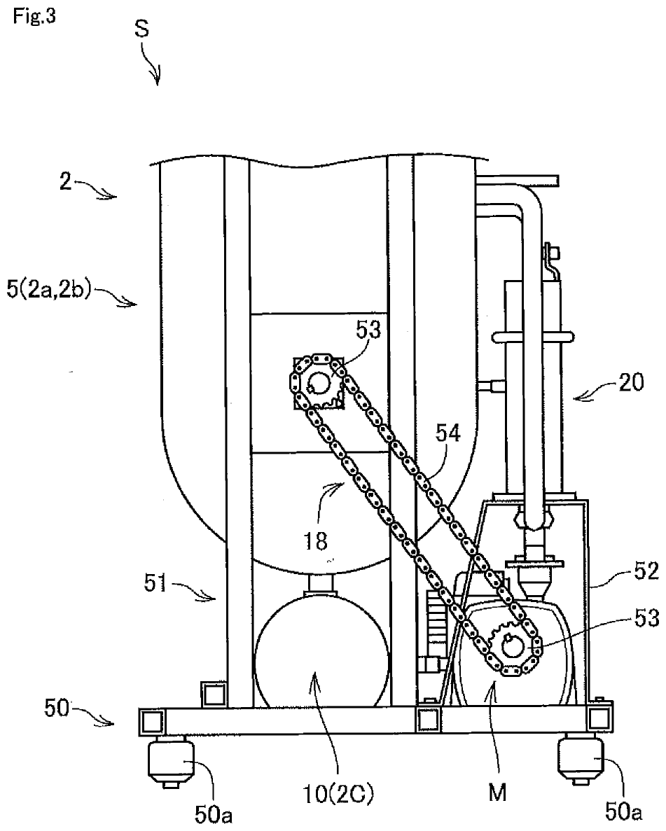

The stirring shaft 16 is supported by bearings 5b and 5b formed in the side walls of the body case 5, and is connected to a driving motor M by a speed reduction mechanism, etc. constituted by gears, not shown, via a transmission mechanism 18 constituted by pulleys 53 and a chain 54 as shown in FIG. 3. This driving motor M is placed behind the subcase 10 and on the base 50.

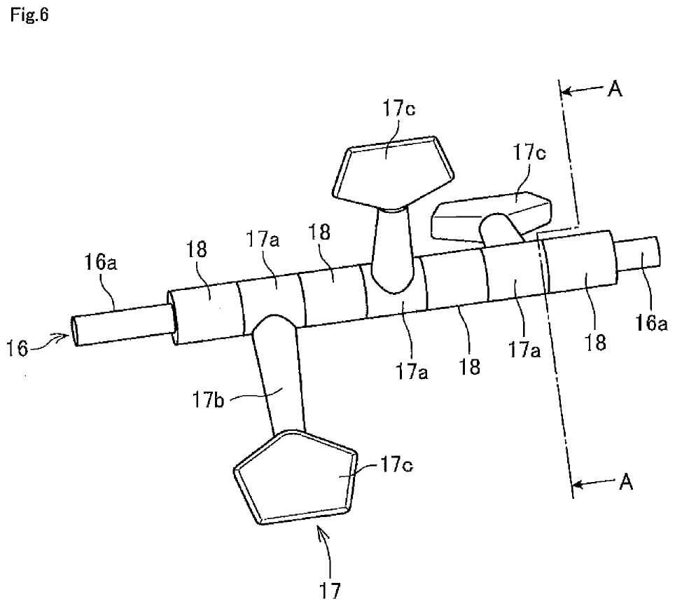

Additionally, as shown in FIG. 6, the stirring shaft 16 includes cylindrical ends 16a and 16a supported by the bearings 5b and 5b, and a center portion whose surface is formed into a polygonal shape, not shown, and the stirring wings 17 are provided in this center portion.

The stirring wing 17 includes an annular connection member 17a, which is attached to the center portion of the stirring shaft, and whose interior is formed into a polygonal shape (for example, a hexagon), a shaft 17b extending in one direction from this connection member 17a, and a spatula-shaped stirring body 17c provided at the tip of the shaft 17b.

A plurality of stirring wings 17 are provided along the axial direction of the stirring shaft 16 by adjusting the interval between the adjacent stirring wings 17 with an interval adjustment member 18 whose interior is formed into a polygonal shape.

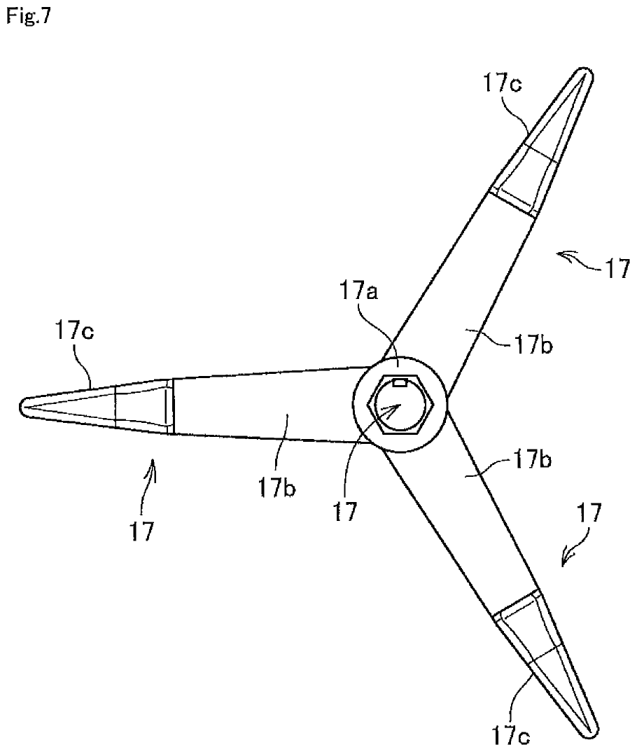

Additionally, as shown in FIG. 7, each of the stirring wings 17 is evenly arranged around the shaft.

Then, the stirring shaft 16 is rotated and driven at a predetermined number of rotations by the forward and reverse rotation driving of the driving motor M, by transmitting the rotation of the driving motor M through the speed reduction mechanism or a transmitter mechanism 18. The stirring wings 17 are rotated with the rotation of this stirring shaft 16, and stir the food waste put into the first processing tank 2a.

Additionally, the tip portions of the stirring wings 17 contact the surface of the partition body 7, and the food waste stirred by the stirring wings 17 and decomposed by the microorganism is ground between the surface of the partition body 7 to fall from the through-holes 7a of the partition body 7 to the second processing tank 2b.

In the food waste processing apparatus S configured in this manner, the food waste subjected to the decomposition processing by the microorganism and stirred by the stirring wings 17 in the first processing tank 2a (hereinafter referred to as “the primary processed material”) falls to the second processing tank 2b via these through-holes 7a and 7a by its own weight or contact with the stirring wings 17. Additionally, the food waste obtained by performing further decomposition processing on the primary processed material by the microorganism in the second processing tank 2b (hereinafter referred to as “the secondary processed material”) passes through the communication passage 9 by its own weight, and falls to the third processing tank 2c.

In this manner, in the food waste processing apparatus S of the present embodiment, the food waste is decomposed by the microorganism in each of the processing tanks 2a to 2c, and is gradually subdivided in the order of the first processing tank 2a, the second processing tank 2b, and the third processing tank 2c.

Note that, in the following description, the food waste on which the decomposition processing has been performed by the microorganism in the third processing tank 2c is referred to as “the third processed material” for convenience. Additionally, this third processed material is specifically a liquid including solid matters, and is referred to as a “waste fluid” for convenience in the following description.

The filter unit 20 filters the waste fluid processed in the processing tank 2 with the filter 21 to remove the solid matters included in the waste fluid.

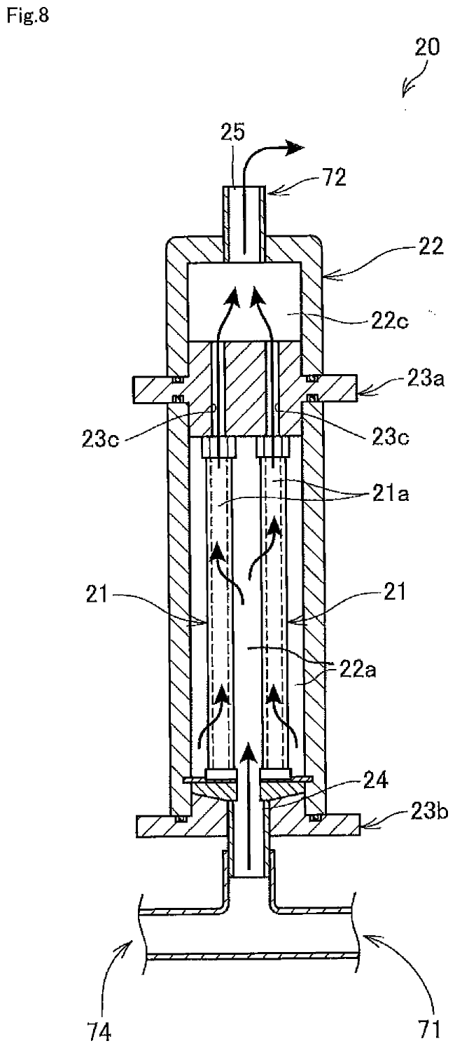

As shown in FIG. 8, the filter unit 20 includes a body 22 including a space inside, and the spring-type filter 21 arranged inside the body 22 and formed into a ring shape.

The upper and bottom ends of the filter 21 are supported by support bodies 23a and 23b, and the support body 23b supporting the lower end of the filter 21 is provided in the bottom of the body 22. Note that, in the filter 21 of the present embodiment, the upper end is fixed and supported by the support body 23a, and the lower end is supported by the support body 23b so as to be able to move in up and down directions.

The inside of the body 22 is divided into a lower space 22a and an upper space 22c by one of the support bodies 23a supporting the upper end of the filter 21, and through-holes 23c communicating the internal space 21a of the filter 21 with the upper space 22c is formed in the support body 23a.

Note that, when the spring-type filter 21 sucks the waste fluid from the outside, springs are pulled inward by its pressure to narrow (eliminate) the gaps between the adjacent springs, so as to separate solid matters and allow only a liquid to pass. On the other hand, when the flow of the waste fluid is reversed from the inside to the outside, the gaps between the springs are opened with the pressure.

Additionally, the body 22 includes two communication ports 24 and 25 in the upper end and the lower end, one communication port 24 formed in the lower end communicates with the lower space 22a of the body 22, and the other communication port 25 formed in the upper end communicates with the internal space 21a of the filter 21 via the upper space 22c of the body 22.

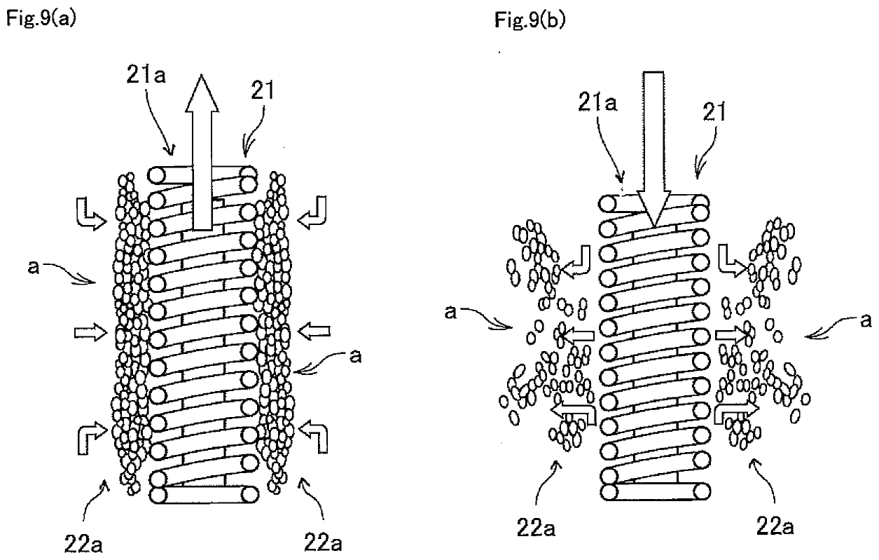

Then, as indicated by the arrows in FIG. 8 and FIG. 9(a), the waste fluid is supplied to the lower space 22a of the body 22 from the one communication port 24 formed in the lower end, passes through the filter 21, and is discharged from the other communication port 25 formed in the upper end of the body 22 after passing through the internal space 21a of the filter 21, the through-holes 23c of the support body 23a, and the upper space 22c of the body 22.

In this manner, when the waste fluid passes through the filter 21, solid matters a adhere to the outer surface of the filter 21, the solid matters a are removed, and the waste fluid is purified.

Additionally, as shown in FIG. 9(b), the filter unit 20 can remove the solid matters a adhered to the outer surface of the filter 21 by sending back the waste fluid from the upper space 22c to the one communication port 24 side. Note that the solid matters a are returned to the first processing tank 2a by using a fourth flow channel 74, which will be described later.

Additionally, as shown in FIG. 1, a first flow channel 71 for communicating the third processing tank 2c with the one communication port 24 of the filter unit 20, and sending the waste fluid processed in the third processing tank to the filter unit, a second flow channel 72 for communicating the other communication port 25 of the filter unit 20 with the storage tank 35, and sending the waste fluid purified by the filter unit to the storage tank 35, a third flow channel 73 for communicating the storage tank 35 with the body case 5, and returning the purified waste fluid accommodated in the storage tank 35 to the first processing tank 2a, and a fourth flow channel 74 for communicating the one communication port 24 of the filter unit 20 with the body case 5, reversing the flow of the purified waste fluid, removing the solid matters adhered to the outer surface of the filter 21, and returning the solid matters to the first processing tank 2a are provided behind the body case 5.

Each of the flow channels 71 to 74 is partially connected to be shared, and valves B1 to B8 for opening and closing the flow channels 71 to 74 are provided in each of the flow channels 71 to 74 divided by the connected portions. Then, each of the valves B1 to B8 is appropriately controlled to be opened or closed, so as to open or close each of the flow channels 71 to 74 to appropriately define the path of the waste fluid.

By sharing each of the flow channels 71 to 74 in this manner, it is possible to simplify the flow channels 71 to 74 and to easily reduce the manufacturing cost.

Additionally, in the present embodiment, a pump P is provided in the first flow channel 71, and the waste fluid flows to each of the flow channels 71 to 74 by the action of this pump P.

Note that the valves B1 to B8 of the present embodiment are manually operated, but may be constituted by electromagnetic valves, etc. In this case, it is preferable that each of the valves B1 to B8 is automatically controlled to be opened and closed by a control apparatus, not shown.

The waste fluid circulation unit 40 is constituted by the third flow channel 73, and with the input of food waste, each of the valves B1 to B8 is appropriately opened and closed and the pump P is driven to return the waste fluid in the storage tank 35 into the first processing tank 2a. This third path 73 is partially shared with the first flow channel 71, and the pump P is arranged in this path. One end of the third flow channel 73 is attached to a lower end side wall of the storage tank 35, and the other end is attached to an upper end of a rear side wall of the body case 5.

Then, the purified waste fluid is discharged from the storage tank 35 via the third flow channel 73 by the action of the pump P, and is supplied into the case body 5. Accordingly, since the food waste is mixed with the waste fluid put in by the waste fluid circulation unit 40, the food waste is softened and easily subdivided by the stirring wings 17.

The washing unit 50 is constituted by the filter unit 20, which functions as a solid matter circulation unit, and the fourth flow channel 74, each of the valves B1 to B8 is appropriately controlled to be opened and closed to reverse the flow of the purified waste fluid temporarily stored in the upper space 22c of the body 22 of the filter unit 20, so as to remove the solid matters adhered to the surface of the filter 21, and to return the solid matters into the first processing tank 2a. Accordingly, since the solid matters adhered to the filter 21 are removed from the filter 21, returned into the first processing tank 2a, and subjected to re-decomposition processing by the microorganism, the food waste processing apparatus S of the present embodiment does not require the disposal processing of the solid matters.

Additionally, the washing unit 50 may further include a fifth flow channel communicating the other communication port 25 of the filter unit 20 with the storage tank 35, and a pump P arranged in the fifth flow channel, and may reverse the flow of a predetermined flow rate of the waste fluid within the filter unit 20.

Note that, in the present embodiment, the fifth flow channel is partially shared with the first to third flow channels 71 to 73, and the pump P is arranged in this path.

Then, the waste fluid in the storage tank 35 is supplied to the other communication port 25 of the filter unit 20 by the action of the pump P, and the flow of the waste fluid is reversed, so as to remove the solid matters adhered to the surface of the filter 21, and return the solid matters into the first processing tank 2a. Accordingly, since the hydraulic pressure against the filter 21 can be easily increased, it is possible to make the solid matters adhered to the filter 21 easily removed.

Additionally, since the solid matters included in the purified waste fluid and the waste fluid are returned into the first processing tank 2a, the food waste processing apparatus S of the present embodiment does not require the disposal processing of the solid matters and the waste fluid.

### (Operation of Food Waste Processing Apparatus)

Next, a series of exemplary operations of the food waste processing apparatus S of the present embodiment will be described. Note that, although a description will be given by assuming that, in the food waste processing apparatus S of the present embodiment, a piece of wood carrying a microorganism and a sponge carrying a microorganism are prepared, and the piece of wood and the sponge are arranged in advance in the first to third processing tanks 2a to 2c, food waste, the piece of wood, and the sponge may be put in the processing tank 2 together.

First, when food waste is put in, the food waste processing apparatus S drives the driving motor M to drive the stirring shaft 16 via the speed reduction mechanism and the transmission mechanism 18 and to rotate the stirring wings 17, so as to stir the food waste in the first processing tank 2a. On this occasion, when a waste fluid is stored in the storage tank 35, the waste fluid is supplied to the first processing tank 2a, but this supply operation of the waste fluid will be described later.

The food waste is subjected to the decomposition processing by the microorganism while being stirred by the stirring wings 17, and moisture falls by its own weight to the second processing tank 2b from the through-holes 7a formed in the partition body 7. On the other hand, when solid matters are subdivided to sizes that allow the solid matters to pass through the through-holes 7a by stirring by the stirring wings 17 and the decomposition processing by the microorganism, the solid matters are pushed out downward from the through-holes 7a by their own weights or while being ground between the tips of the stirring wings 17, and fall to the second processing tank 2b.

Additionally, in the second processing tank 2b, the primary processed material is further subjected to the decomposition processing by the microorganism, and is stored until the decomposition processing is performed until a size of the primary processed material allows it to pass through the communication passage 9. Then, the primary processed material processed in the second processing tank 2b is discharged by its own weight to the third processing tank 2c via the communication passage 9 as the secondary processed material.

The third processing tank 2c temporarily stores the third processed material (waste fluid) generated by further performing the decomposition processing on the secondary processed material by the microorganism. Note that the waste fluid subjected to the decomposition processing in the third processing tank 2c is subjected to the decomposition processing until the solid matters have sizes that allow the solid matters to pass through the first flow channel 71.

This waste fluid is stored in the storage tank 35 after removing the solid matters included in the waste fluid with the filter 21 of the filter unit 20, and separating the waste fluid into a liquid form.

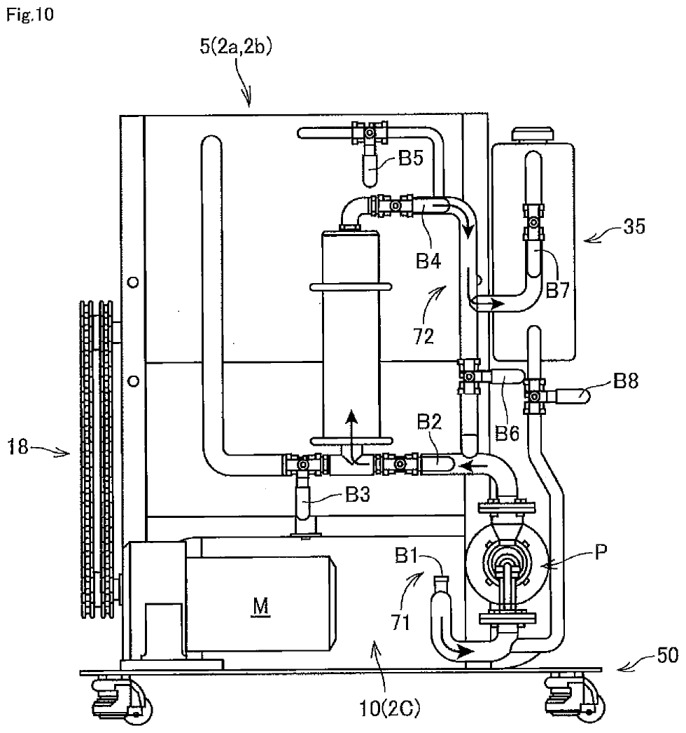

Here, using FIG. 10, a description will be given of an exemplary operation of purifying the waste fluid stored in the third processing tank 2c, and storing the waste fluid in the storage tank 35. As shown in FIG. 10, the waste fluid processed in the third processing tank 2c is sent to the storage tank 35 by using the first flow channel 71 and the second flow channel 72.

First, the valves B3, B5, B6 and B8 are operated to be closed, the valves B1, B2, and B4 and B7 are operated to be opened, and the pump P is operated to be driven. With this operation, the waste fluid flows through the first flow channel 71 and is supplied to the filter unit 20. Then, in the filter unit 20, the solid matters included in the waste fluid are removed with the filter 21 and is discharged as a purified liquid, and the discharged waste fluid flows through the second flow channel 72 and is stored in the storage tank 35.

Additionally, the waste fluid stored in the storage tank 35 is returned to the first processing tank 2a in the case body 5, and is reused for the decomposition processing of food waste.

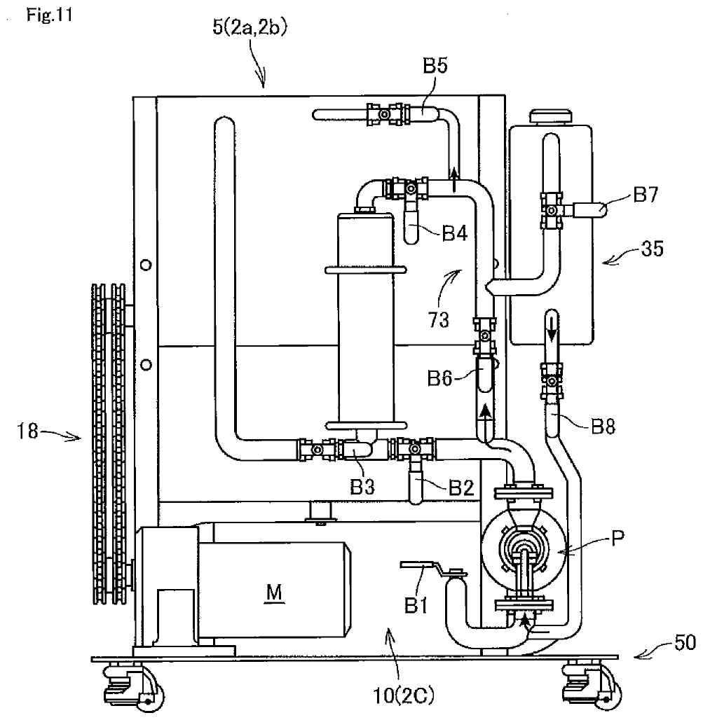

Here, using FIG. 11, a description will be given of an exemplary operation of returning the waste fluid stored in the storage tank 35 to the processing tank 2. As shown in FIG. 11, the waste fluid is sent to the first processing tank 2a in the case body 5 by using the third flow channel 73.

First, the valves B1, B2, B4 and B7 are operated to be closed, the valves B5, B6 and B8 are operated to be opened, and the pump P is operated to be driven. With this operation, the waste fluid accommodated in the storage tank 35 flows through the third flow channel 73, and is supplied to the first processing tank 2a of the case body 5.

By reusing the waste fluid in this manner when performing the decomposition processing of the food waste, the microorganism can be activated. Additionally, since the solid matters can be softened by dosing of moisture, the stirring by the stirring wings 17 can be easily performed, and the decomposition processing can be accelerated. Additionally, since the liquid put into the decomposition processing of the food waste is the waste fluid, it is unnecessary to provide a new facility for supplying the liquid, and the reduction of the running cost can be achieved.

Additionally, the food waste processing apparatus S of the present embodiment appropriately includes a function of washing the filter unit 20.

Here, an exemplary operation of washing the filter 21 of the filter unit 20 will be described by using the figures. As shown in FIG. 8, the waste fluid purified with the filter 21 is stored in the upper space 22c of the filter unit 20, and by operating the valve B3 to be opened, the flow of the waste fluid stored in this upper space 22c is reversed by its own weight, and passes through the filter 21.

Then, the waste fluid contacts the solid matters adhered to the surface of the filter 21 at a predetermined hydraulic pressure, and removes the solid matters from the filter 21. The solid matters removed from the filter 21 flow through the fourth flow channel 74, are returned to the first processing tank 2a of the case body 5, and are subjected to the re-decomposition processing. Accordingly, the food waste processing apparatus S of the present embodiment does not require the disposal processing of the solid matters.

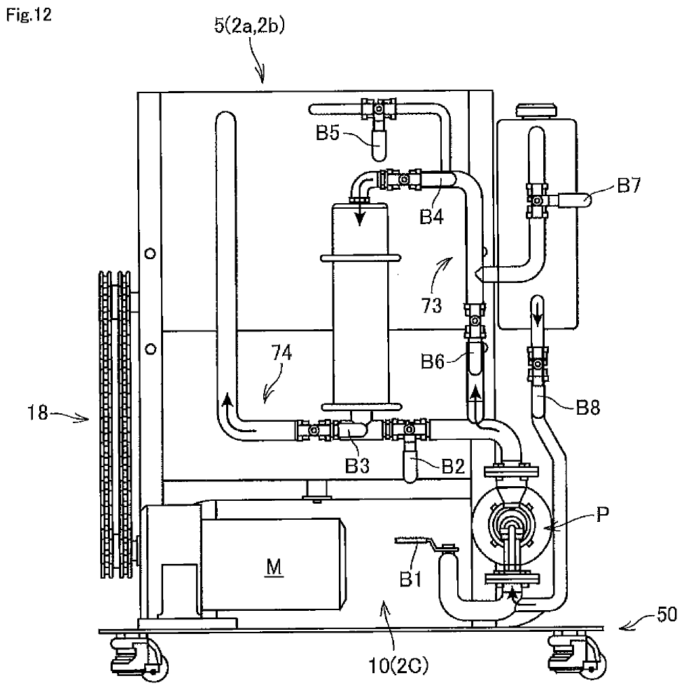

Next, using FIG. 12, another exemplary operation of washing the filter will be described. This exemplary operation increases the hydraulic pressure so that the waste fluid contacts the filter 21, and is performed by using the fifth flow channel in addition to the fourth flow channel 74.

First, the valves B1, B2, B5 and B7 are operated to be closed, and the valves B3, B4, B6 and B8 are operated to be opened, and the pump P is operated to be driven. With this operation, the waste fluid accommodated in the storage tank 35 flows through the fifth flow channel, is supplied to the exit side of the filter unit 20, and flows back through the filter unit 20 to pass through the filter 21.

Then, the waste fluid contacts the solid matters adhered to the surface of the filter 21 at the predetermined hydraulic pressure, and removes the solid matters from the filter 21. The solid matters removed from the filter 21 flow through the fourth flow channel 74, are returned to the first processing tank 2a of the case body 5, and are subjected to the re-decomposition processing. Accordingly, the food waste processing apparatus S of the present embodiment does not require the disposal processing of the solid matters.

In this manner, the food waste processing apparatus S of the present embodiment circulates again (reuses) the waste fluid subjected to the decomposition processing by the microorganism, and does not require the disposal processing of the waste fluid. Additionally, since the waste fluid is reused in the food waste processing, it is unnecessary to newly provide a supplying apparatus of water, and further, since the food waste can be easily turned into a paste and can be easily subdivided by supplying this waste fluid, the decomposition processing can be activated. Even when the capacity of the storage tank 35 is exceeded, the waste fluid can be reused since it is the purified liquid, and the disposal processing is easy since pipes of the sewer, etc. will not be clogged.

Additionally, since the food waste processing apparatus S can appropriately remove the solid matters adhered to the filter 21, the filter 21 is not easily clogged, and since it is possible to extend the service life of the filter 21, the maintenance of a filter is easy.

Further, since the food waste processing apparatus S performs the decomposition processing again on the solid matters included in the waste fluid subjected to the decomposition processing by the microorganism, the disposal processing of the solid matters is not required.

Note that the present invention is not limited to the above-described embodiment, and can be modified in various ways within a scope that does not change the gist of the present invention. For example, in the food waste processing apparatus S of the present embodiment, although the processing tank 2 is divided into the first to third processing tanks, the number of the processing tanks is not particularly limited.

### REFERENCE SIGNS LIST

S food waste processing apparatus
2 processing tank
20 filter unit
21 filter
35 storage tank
40 waste fluid circulation unit
50 washing unit
71 first flow channel
72 second flow channel
73 third flow channel
74 fourth flow channel

1. An organic matter processing apparatus, comprising:
a processing tank in which decomposition processing of organic matter is performed by a microorganism;
a filter unit including a filter for filtering solid matter included in a waste fluid generated by the decomposition processing;
a reservoir that stores the waste fluid from which the solid matter is removed by the filter unit; and
a waste fluid circulation unit that returns the waste fluid stored in the reservoir to the processing tank.

2. The organic matter processing apparatus according to claim 1, comprising a washing unit that removes the solid matter adhered to the filter to wash the filter unit.

3. The organic matter processing apparatus according to claim 2, wherein the washing unit includes a solid matter circulation unit that returns the solid matter removed from the filter to the processing tank.

4. The organic matter processing apparatus according to claim 1, wherein the solid matter circulation unit sends back the waste fluid discharged from the filter unit to the filter unit.

5. The organic matter processing apparatus according to claim 1, comprising:
a first flow channel that communicates the processing tank with one end side of the filter unit;
a second flow channel that communicates the other end side of the filter unit with the reservoir;
a third flow channel that communicates the reservoir with the processing tank;
a fourth flow channel that communicates the one end side of the filter unit with the processing tank;
valves that open or close the respective flow channels; and
a control unit that controls opening and closing of each of the valves,
wherein the control unit opens or closes each of the valves to open or close each of the flow channels.

6. An organic matter processing method, comprising:
a decomposition processing step of performing decomposition processing of organic matter by a microorganism in a processing tank into which the organic matter is put;
a solid matter removing step of removing solid matter included in a waste fluid generated by the decomposition processing; and
a waste fluid circulating step of returning the waste fluid from which the solid matter is removed to the processing tank.
